(19) United States
(12) Patent Application Publication
(10) Pub. No.: US 2026/0187754 A1
(43) Pub. Date: Jul. 2, 2026

(54) METHOD, APPARATUS AND ELECTRONIC DEVICE FOR DISPLAYING IMAGE

(71) Applicant: Beijing Youzhuju Network Technology Co., Ltd., Beijing (CN)

(72) Inventor: Hao SUN, Beijing (CN)

(21) Appl. No.: 18/836,684

(22) PCT Filed: Feb. 7, 2023
(86) PCT No.: PCT/CN2023/074828

§ 371 Date: Aug. 7, 2024

(30) Foreign Application Priority Data
Feb. 8, 2022 (CN) 202210119646.6

(51) Int. Cl. G06T 3/4038; G06T 7/70

(52) U.S. Cl. CPC G06T 3/4038; G06T 7/70; G06T 2207/30244

(57) ABSTRACT

Embodiments of the disclosure provide a method, an apparatus and an electronic device for displaying an image. One particular embodiment of the method includes: obtaining at least two real-scene images acquired by a virtual reality camera and image acquisition positions of the real-scene images; generating point cloud images corresponding to the real-scene images based on the real-scene images; determining display positions of image acquisition points in a position coordinate system based on the image acquisition positions of the real-scene images; displaying each of the point cloud images based on the display positions, where the displayed point cloud images are used to be spliced to generate panoramic point cloud data.

### CROSS REFERENCE

This application claims priority to Chinese Patent Application No. 202210119646.6, filed on Feb. 8, 2022 and entitled “METHOD, APPARATUS AND ELECTRONIC DEVICE FOR DISPLAYING IMAGE”, which is incorporated herein by reference in its entirety.

### FIELD

The disclosure relates to the field of computer technologies, and in particular, to a method, an apparatus and an electronic device for displaying an image.

### BACKGROUND

With the development of computer technologies, a virtual reality (VR) technology is recognized by more and more people, and a user may have the most realistic experience in a virtual real world. Reality of an environment simulated by the virtual reality is difficult to distinguish from that of a real world, so that the person has an immersive feeling.

An image displayed for a virtual real world may be acquired from the real world. A virtual reality camera may be used to acquire the image from the real world.

### SUMMARY

This Summary section is provided to introduce the concepts in a simplified form, and the concepts are described in detail in the following Detailed Description section. This Summary section is not intended to identify key features or essential features of the claimed subject matter, nor is it intended to be used to limit the scope of the claimed subject matter.

In a first aspect, an embodiment of the disclosure provides a method for displaying an image, including: obtaining at least two real-scene images acquired by a virtual reality camera and image acquisition positions of the real-scene images; generating point cloud images corresponding to the real-scene images based on the real-scene images; determining display positions of image acquisition points in a position coordinate system, based on the image acquisition positions of the real-scene images; displaying each of the point cloud images based on the display positions, where the displayed point cloud images are used to be spliced to generate panoramic point cloud data.

In a second aspect, an embodiment of the disclosure provides an apparatus for displaying an image, including: an obtaining unit configured to obtain at least two real-scene images acquired by a virtual reality camera and image acquisition positions of the real-scene images; a generating unit configured to generate point cloud images corresponding to the real-scene images based on the real-scene images; a determining unit configured to determine display positions of image acquisition points in a position coordinate system, based on the image acquisition positions of the real-scene images; a displaying unit configured to display each of the point cloud images based on the display positions, where the displayed point cloud images are used to spliced to generate panoramic point cloud data.

In a third aspect, an embodiment of the disclosure provides an electronic device, including: one or more processors; and a storage device configured to store one or more programs, the one or more programs, when executed by the one or more processors, causing the one or more processors to implement the method for displaying an image based on the first aspect.

In a fourth aspect, an embodiment of the disclosure provides a computer readable medium having a computer program stored thereon, the computer program, when executed by a processor, implementing the steps of the method for displaying an image based on the first aspect.

The method, apparatus and electronic device for displaying an image provided in the embodiments of the disclosure obtains real-scene images by a virtual reality camera, and obtains at least two real-scene images acquired by the virtual reality camera and image acquisition positions of the real-scene images; generates point cloud images corresponding to the real-scene images based on the real-scene images; then determines display positions of image acquisition points in a position coordinate system based on the image acquisition positions of the real-scene images; and then displaying the point cloud images based on the display positions. Thus, the generated point cloud images may be separate based on the real image acquisition positions, thereby improving the speed of generating panoramic point cloud data by splicing the point cloud images.

### BRIEF DESCRIPTION OF THE DRAWINGS

The above and other features, advantages, and aspects of various embodiments of the disclosure will become more apparent with reference to the following Detailed Description taken in conjunction with the accompanying drawings. The same or like reference numerals represent the same or like elements throughout the drawings. It is to be understood that the drawings are illustrative and that the elements and primaries are not necessarily drawn to scale.

FIG. 1 is a flowchart of one embodiment of a method for displaying an image according to the disclosure;

FIG. 2 is a schematic diagram of a virtual reality camera and a pan tilt in which the present application may be applied;

FIGS. 3A and 3B are schematic diagrams of one application scenario of a method for displaying an image according to the disclosure;

FIG. 4 is a flowchart of one implementation of a method for displaying an image in accordance with the disclosure;

FIG. 5 is a schematic structural diagram of one embodiment of an apparatus for displaying an image according to the disclosure;

FIG. 6 is an example system architecture in accordance with an embodiment of the disclosure, in which a method for displaying an image may be applied;

FIG. 7 is a schematic diagram of a basic structure of an electronic device according to an embodiment of the disclosure.

### DETAILED DESCRIPTION

Embodiments of the disclosure will be described in more detail below with reference to the accompanying drawings. Although certain embodiments of the disclosure are shown in the drawings, it should be understood that the disclosure may be implemented in various forms and should not be construed as being limited to the embodiments set forth herein. Instead, these embodiments are provided for a thorough and complete understanding of the disclosure. It should be understood that the drawings and embodiments of the disclosure are only for illustrative purposes and are not intended to limit the scope of the disclosure.

It should be understood that the steps described in method embodiments of the disclosure may be performed in different orders, and/or performed in parallel. Furthermore, the method embodiments may include additional steps and/or omit performing of the illustrated steps. The scope of the disclosure will not be limited in this respect.

The term “comprising” and variations thereof, as used herein, is inclusive, i.e., “including but not limited to”. The term “based on” is “based at least in part on”. The term “one embodiment” means “at least one embodiment”; the term “another embodiment” means “at least one further embodiment”. The term “some embodiments” means “at least some embodiments”. Relevant definitions of other terms will be given in the following description.

It should be noted that the “first”, “second” and/or the like mentioned in the disclosure are only used to distinguish different apparatuses, modules, or units, but are not used to limit the sequence or dependency of functions performed by these apparatuses, modules, or units.

It should be noted that the modifications of “a” and “a plurality” mentioned in the disclosure are illustrative rather than limited, and those skilled in the art should understand that they should be understood as “one or more” unless the context clearly indicates otherwise.

The names of messages or information interacted between a plurality of devices in the embodiments of the disclosure are only for illustrative purposes, and are not intended to limit the scope of these messages or information.

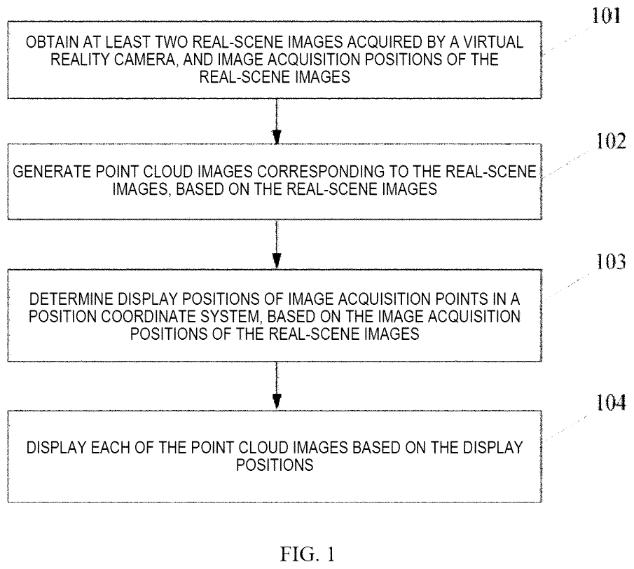

Reference is made to FIG. 1, which shows a flow of one embodiment of a method for displaying an image according to the disclosure.

In this embodiment, as shown in FIG. 1, the method for displaying an image includes the following steps.

In step 101, at least two real-scene images acquired by a virtual reality camera and image acquisition positions of the real-scene images are obtained.

In this embodiment, the virtual reality camera may acquire real-scene images, and the real-scene images acquired by the virtual reality camera may correspond to at least two image acquisition positions.

In other words, the virtual reality camera may acquire the real-scene images at the at least two image acquisition positions; and the virtual reality camera may acquire at least one group of real-scene images at each image acquisition position, and each group of real-scene images may include at least one real-scene image.

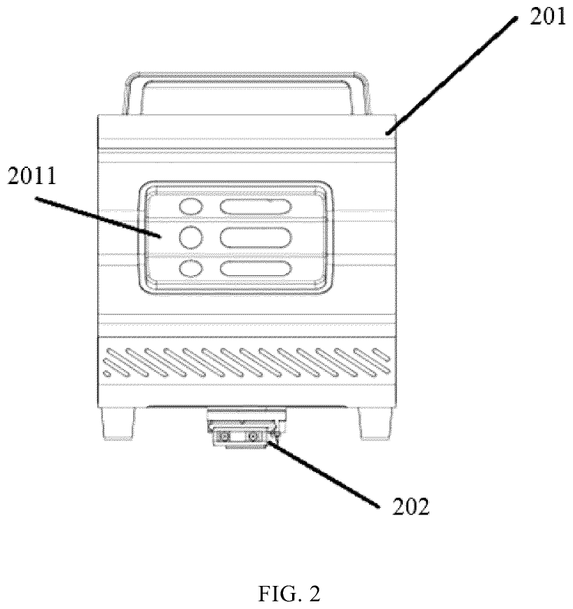

In some application scenarios, reference is made to FIG. 2 which shows a virtual reality camera and a pan tilt in which some embodiments of the present application may be applied.

As an example, the virtual reality camera and the pan tilt 202 in FIG. 2 may be connected to each other. The virtual reality camera may be mounted and fixed on the pan tilt. The virtual reality camera may control the pan tilt using control instructions, that is, communication may be performed between the virtual reality cameras and the pan tilt.

As an example, the virtual reality camera in FIG. 2 may further include an image acquisition component 2011, which may include one or more image acquisition components.

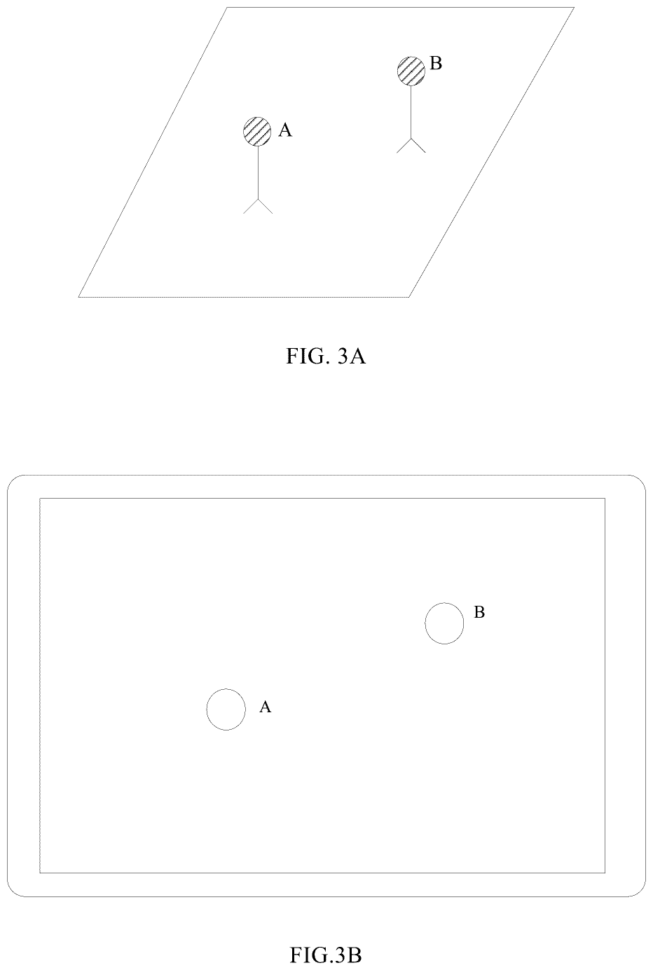

In some application scenarios, reference is made to FIG. 3A which shows an example scenario where a virtual reality camera acquires a real-scene image.

As an example, the virtual reality camera may be placed at a point A, and then the virtual reality camera is rotated. During rotation of the virtual reality camera, the virtual reality camera may acquire a first group of real-scene images. Then, the virtual reality camera is moved from the point A to a point B, and the virtual reality camera is rotated; and during the rotation of the virtual reality camera, the virtual reality camera may acquire a second group of real-scene images. Here, the first group of real-scene images correspond to the point A, and the point A is an image acquisition position of the first group of real-scene images; the second group of real-scene images correspond to the point B, where the point B is an image acquisition position of the second group of real-scene images.

In step 102, point cloud images corresponding to the real-scene images are generated based on the real-scene images.

Here, each real-scene image may be converted into a point cloud image. The point cloud is a massive point set representing target spatial distribution and target surface characteristics in the same spatial reference system. After a spatial coordinate of each sampling point of a surface of an object is obtained, a point set is obtained, which is referred to as a “point cloud”. The point cloud images may be obtained by converting real-scene images since there are a plurality of real-scene images; and the point cloud in the point cloud image obtained by converting each real-scene image, which may be a part of points in a space.

In step 103, display positions of the image acquisition points in the position coordinate system are determined based on image acquisition positions of the real-scene images.

In this embodiment, an image acquisition position of a real-scene image may indicate a position in a real space. When a point cloud image is displayed, a position coordinate system corresponding to the real space may be established in a computer, and each point in the position coordinate system has a corresponding relationship with each point in the real space.

It can be understood that the image acquisition point in the real space has a corresponding display position in the position coordinate system. Thus, various points in a real-scene image in the real space are converted into a position coordinate system, to obtain a point cloud image in the position coordinate system.

In step 104, each of the point cloud images are displayed based on the display positions.

The displayed point cloud images are used to be spliced to generate panoramic point cloud data.

As an example, reference is made to FIG. 3B which shows an example scenario of displaying a point cloud image.

In FIG. 3B, an image acquisition point A corresponds to a display position A′ in the position coordinate system, and an image acquisition point B corresponds to a display position B′ in the position coordinate system. The position relationship between the point cloud image corresponding to the first group of real-scene images and the display position A′ is consistent with the position relationship between the first group of real-scene images and the image acquisition point A. The position relationship between the point cloud image corresponding to the second group of real-scene images and the display position B′ is consistent with the position relationship between the first group of real-scene images and the image acquisition point B. Furthermore, the position relationship between the display position A′ and the display position B′ is consistent with the position relationship between the image acquisition point A and the image acquisition point B. It is to be understood that the real-scene image and the point cloud image are not shown.

It should be noted that the method for displaying an image provided by this embodiment acquires real-scene images by using a virtual reality camera, and obtains at least two real-scene images acquired by the virtual reality camera and image acquisition positions of the real-scene images; generating point cloud images corresponding to the real-scene images based on the real-scene images; then, determines display positions of image acquisition points in a position coordinate system based on image acquisition positions of the real-scene images; displays the point cloud images based on the displayed positions. As a result, the generated point cloud images may be separate based on the actual image acquisition locations, improving the speed of generating the panoramic point cloud data by splicing the point cloud images.

In contrast, in some related technologies, during a process where a VR camera captures images, the camera may capture the images at a plurality of locations in a room. The point cloud images generated after the capturing is completed are assumed to have overlapping capturing points. An operator needs to manually move positions of the capturing points to the corresponding positions, and an alignment process is quite cumbersome and time-consuming. Only after the alignment, the point cloud integration may be generated.

In some embodiments, the method further includes displaying position indication information at each of the display positions.

As an example, referring to FIG. 3B, a pattern such as a black dot and/or the like may be used as the position indication information to indicate the display position. For example, the display position A′ and the display position B′ are indicated by different black dots in FIG. 3B.

It should be noted that the displayed position indication information clearly indicates a position, to clearly display, to a user, an image acquisition position automatically determined by a machine. Thus, the user may determine, based on the displayed position indication information, whether the position automatically determined by the machine is correct, thereby avoiding errors of the point cloud images due to incorrect display positions, and improving the accuracy of the generated panoramic point cloud data.

In some embodiments, the method further includes: in response to a movement operation on the displayed position indication information, moving the position indication information based on the movement operation, and moving a point cloud image of the point cloud images corresponding to the position indication information.

Here, the user may move the position indication information, and along with the movement of the position indication information, the point cloud image corresponding to the position indication information also moves accordingly.

Thus, in the case where an automatically generated display position has an error, by receiving information about an adjustment action of a user, the point cloud data may be adjusted based on the adjustment by the user, thereby improving the accuracy of the panoramic point cloud data.

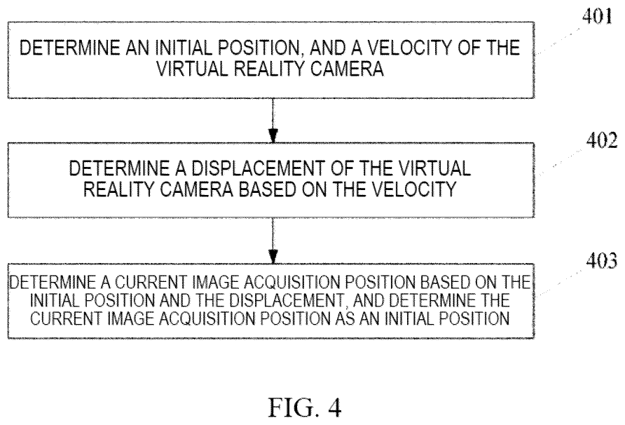

In some embodiments, reference is made to FIG. 4 which shows a schematic flow of a step of determining an acquisition point position.

Here, the image acquisition position may be determined by the step of determining an acquisition point position.

As shown in FIG. 4, the step of determining the acquisition point position may include:

In Step 401, an initial position is determined, and a velocity of the virtual reality camera is determined.

Here, the initial position may be a position of the virtual reality camera whenever the virtual reality camera starts to move.

As an example, the virtual reality camera has three image acquisition positions in a room. When the virtual reality camera moves from a first image acquisition position to a second image acquisition position, the first image acquisition position is an initial position; when the virtual reality camera moves from the second image acquisition position to a third image acquisition position, the second image acquisition position is an initial position.

Here, the velocity of the virtual reality camera in the moving process may be obtained, which is the velocity of moving the virtual camera.

In step 402, a displacement of the virtual reality camera is determined based on the velocity.

Here, the displacement of the virtual reality camera may be determined based on the obtained velocity. The velocity may be a vector, and the displacement may be a vector.

Alternatively, the displacement may be determined based on the velocity and time.

In step 403, a current image acquisition position is determined based on the initial position and the displacement, and the current image acquisition position is determined as the initial position.

Here, the displacement vector is superimposed on the basis of the initial position to obtain the current image acquisition position. After the current image acquisition position is determined, the position at which the current image acquisition is completed may be determined as an initial position, to, therefore, determine an accurate initial position for a next round of moving the virtual reality camera.

Thus, it may be achieved to automatically determine the image acquisition position by the machine.

In some embodiments, the virtual reality camera includes an inertial component.

Here, the inertial component, which may be referred to as an inertial measurement component, may include at least one of, but is not limited to, inertial elements such as an accelerometer and a gyroscopic. Data measured by the inertial component in the virtual reality camera is generally a motion change of a carrier relative to an inertial system. Alternatively, the inertial component may be used to indicate a position and/or pose of the virtual reality camera.

In some embodiments, step 401 may include: determining pose information of the virtual reality camera based on first measurement data of the inertial component; determining the velocity of the virtual reality camera based on second measurement data of the inertial component and the pose information.

The first measurement data of a pose measuring component, such as a gyroscope, in the inertial component may be used to determine the pose information of the virtual reality camera.

The second measurement data of a acceleration measuring component of the inertial component may be used to determine the acceleration.

Here, the pose and acceleration may be used to determine the velocity of the virtual reality camera.

It should be noted that the difficulty in determining the pose data may be reduced by additionally arranging an inertial component in the virtual reality camera and determining the velocity of the virtual camera by using the inertial component. Specifically, measurement data of the inertial component in the camera may be sent to a processor in the virtual reality camera in real time, and the processor may generate a velocity based on the measurement data. Thus, the pose data of the virtual reality camera during the rotation may be conveniently determined.

In some embodiments, the inertial component includes a gyroscope and an accelerometer.

In some embodiments, determining the velocity of the virtual reality camera based on the second measurement data of the inertial component and the pose information includes: converting, based on the pose information, an inertial acceleration measured by the accelerometer into a navigation acceleration in a navigation coordinate system; determining the velocity of the virtual reality camera in the position coordinate system based on the navigation acceleration.

Here, a specific force component of a coordinate system of the carrier measured by the acceleration may be converted into the navigation coordinate system (coordinate system conversion) based on the pose of the inertial component; the velocity of the carrier with respect to the Earth is obtained by solving a specific force equation by integral in the navigation coordinate system (removing the Earth's gravitational acceleration). Thus, the velocity of the virtual reality camera in the position coordinate system may be determined.

In some embodiments, step 402 may include determining the displacement of the virtual reality camera in the position coordinate system, by integral of the velocity of the virtual reality camera in the position coordinate system.

Here, by integrating the velocity to obtain the displacement, an accurate displacement may be obtained. Specifically, in the process of moving the virtual reality camera, it may be difficult that a velocity and a direction of the virtual reality camera are constant. A velocity change or a direction change in the moving process may be refined by means of integration, thereby improving the accuracy of the determined displacement.

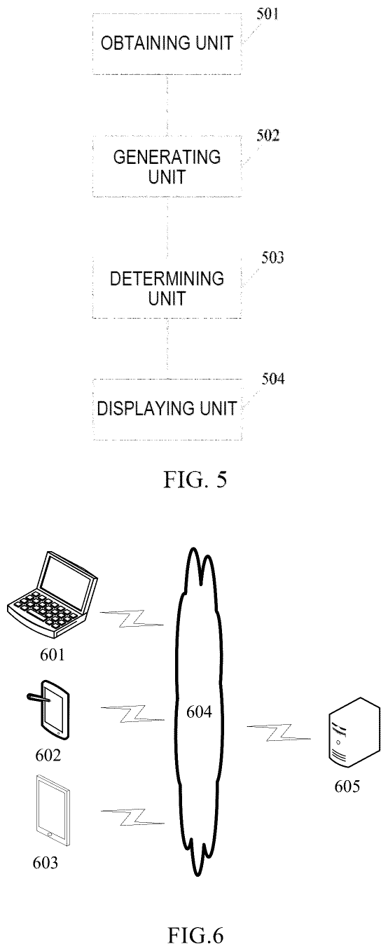

Further referring to FIG. 5, as an implementation of the method shown in the above figures, the disclosure provides an embodiment of an apparatus for displaying an image. A virtual reality camera is connected to a pan tilt. The embodiments of the apparatus corresponds to the embodiments of the method shown in FIG. 1, and the apparatus may be specifically applied to various electronic devices.

As shown in FIG. 5, the apparatus for displaying an image in this embodiment includes: an obtaining unit 501, a generating unit 502, a determining unit 503 and a displaying unit 504. The obtaining unit is configured to obtain at least two real-scene images acquired by a virtual reality camera and image acquisition positions of the real-scene images; the generating unit is configured to generate point cloud images corresponding to the real-scene images based on the real-scene images; the determining unit is configured to determine display positions of the image acquisition points in a position coordinate system based on image acquisition positions of the real-scene images; the displaying unit is configured to display each of the point cloud images based on the display positions, where the displayed point cloud images are used to be spliced to generate panoramic point cloud data.

In this embodiment, specific processing and technical effects thereof by the obtaining unit 501, the generating unit 502, the determining unit 503 and the displaying unit 504 of the apparatus for displaying an image may refer to related descriptions of step 101, step 102, step 103 and step 104 in the corresponding embodiments in FIG. 1, which are not repeated herein.

In some embodiments, the image acquisition positions are determined by a step of determining an acquisition point position, where the step of determining an acquisition point position includes: determining an initial position, and determining the velocity of the virtual reality camera; determining a displacement of the virtual reality camera based on the velocity; and determining a current image acquisition position based on the initial position and the displacement, and determining the current image acquisition position as the initial position.

In some embodiments, the virtual reality camera includes an inertial component, and the determining a motion velocity of the virtual reality camera from the initial position includes: determining pose information of the virtual reality camera based on first measurement data of the inertial component; determining the velocity of the virtual reality camera based on second measurement data of the inertial component and the pose information.

In some embodiments, the inertial component includes a gyroscope and an accelerometer; and determining the velocity of the virtual reality camera based on the second measurement data of the inertial component and the pose information, includes: converting an inertial acceleration measured by the accelerometer into a navigation acceleration in a navigation coordinate system based on the pose information; determining the velocity of the virtual reality camera in the position coordinate system based on the navigation acceleration.

In some embodiments, determining the displacement of the virtual reality camera based on the velocity includes determining the displacement of the virtual reality camera in the position coordinate system, by integral of the velocity of the virtual reality camera in the position coordinate system.

In some embodiments, the apparatus is further configured to display position indication information at each of the display positions.

In some embodiments, the apparatus is further configured to, in response to a movement operation on the displayed position indication information, move the position indication information based on the movement operation and move a point cloud image of the point cloud images corresponding to the position indication information.

Reference is made to FIG. 6 which illustrates an example system architecture according to an embodiment of the disclosure, in which the method for displaying an image may be applied.

As shown in FIG. 6, the system architecture may include a terminal device 601, 602 and 603, a network 604, and a server 605. The network 604 is a medium for providing a communication link between the terminal device 601, 602 and 603 and the server 605. The network 604 may include various connection types, such as wired or wireless communication links, or fiber optic cables, and/or the like.

The terminal devices 601, 602 and 603 may interact with the server 605 via the network 604 to receive or send messages, etc. Various client applications may be installed on the terminal devices 601, 602 and 603, including, for example, a web browser application, a search application, and a news and information application. The client applications in the terminal devices 601, 602 and 603 may receive an instruction from a user, and complete corresponding functions according to the instruction from the user. For example, corresponding information is added to the information according to the instruction from the user.

The terminal devices 601, 602 and 603 may be hardware or software. When the terminal devices 601, 602 and 603 are hardware, the terminal devices 601 may be various electronic devices having a display screen and supporting webpage browsing, including but not limited to a smart phone, a tablet computer, an e-book reader, and a Moving Picture Experts Group Audio Layer III (MP3) player, a Moving Picture Experts Group Audio Layer IV (MP4) player, a laptop computer, a desktop computer, and the like. When the terminal device 601, 602, and 603 is software, the terminal device 601, 602, and 603 may be installed in the foregoing listed electronic devices. They may be implemented as a plurality of pieces of software or software modules (for example, software or software modules for providing a distributed service), or may be implemented as a single piece of software or software module. No limitation will be given herein.

The server 605 may be a server providing various services, for example, receiving information obtaining requests sent by the terminal devices 601, 602, and 603, and acquiring, based on the information obtaining requests, display information corresponding to the information obtaining requests in various manners. The data related to the display information is sent to the terminal devices 601, 602, and 603.

It should be noted that, the method for displaying an image provided in the embodiment of the disclosure may be executed by a terminal device. Accordingly, the apparatus for displaying an image may be provided in the terminal devices 601, 602, and 603. In addition, the method for displaying an image provided in the embodiment of the disclosure may also be performed by the server 605. Accordingly, the apparatus for displaying an image may be provided in the server 605.

It should be understood that the number of terminal devices, networks, and servers in FIG. 6 are merely illustrative, and any number of terminal devices, networks, and servers may be present depending on the implementation needs.

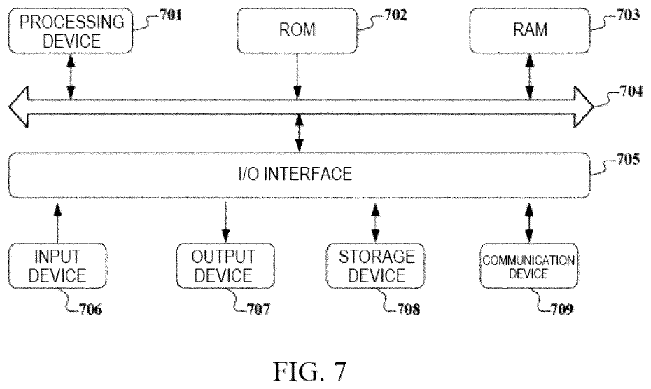

Reference is now made to FIG. 7 which shows a block diagram of an electronic device (e. g., a terminal device or server in FIG. 6) suitable for implementing embodiments of the disclosure. The terminal device in the embodiment of the disclosure may include, but is not limited to, a mobile terminal such as a mobile phone, a laptop computer, a digital broadcast receiver, a Personal Digital Assistant (PDA), a PAD (tablet computer), a Portable Multimedia Player (PMP), an in-vehicle terminal (such as an in-vehicle navigation terminal) and/or the like, and a fixed terminal such as a digital TV, a desktop computer and/or the like. The electronic device shown in FIG. 7 is merely an example and should not suggest any limitation to the functions and use scope of embodiments of the disclosure.

As shown in FIG. 7, the electronic device may include a processing device (e. g., a central processing unit, a graphic processor, etc.) 701 that may perform various suitable actions and processes in accordance with a program stored in a read only memory (ROM) 702 or a program loaded into a random access memory (RAM) 703 from a storage device 708. A variety of programs and data necessary for the operation of the electronic device 700 are also stored in the RAM 703. The processing device 701, the ROM 702, and the RAM 703 are connected to each other via a bus 704. An input/output (I/O) interface 705 is also connected to the bus 704.

In general, the following devices may be connected to the I/O interface 705: an input device 706 including, for example, a touch screen, a touch pad, a keyboard, a mouse, a camera, a microphone, an accelerometer, a gyroscope, and/or the like; an output device 707 including, for example, a liquid crystal display (LCD), a speaker, a vibrator, or the like; a storage device 708 including, for example, a magnetic tape, a hard disk, and/or the like; and a communication device 709. The communication device 709 may allow the electronic device to communicate in a wireless or wired way with other devices to exchange data. While FIG. 7 illustrates an electronic device having a variety of means, it is to be understood that it is not required that all of the illustrated means be implemented or provided. More or fewer devices may alternatively be implemented or provided.

In particular, the processes described above with reference to the flowcharts may be implemented as computer software programs in accordance with embodiments of the disclosure. For example, embodiments of the disclosure include a computer program product including a computer program carried on a non-transitory computer-readable medium, the computer program including program code for performing the method as shown in the flowchart. In such an embodiment, the computer program may be downloaded and installed from the network through the communication device 709, installed from the storage device 708, or installed from the ROM 702. When the computer program is executed by the processing apparatus 701, the described functions defined in the method according to the embodiment of the disclosure are performed.

It should be noted that the computer readable medium in the disclosure may be a computer readable signal medium or a computer readable storage medium, or any combination thereof. A computer-readable storage medium may be, for example, but not limited to, an electronic, magnetic, optical, electromagnetic, infrared or semiconductor system, apparatus, or device, or any suitable combination of the foregoing. More specific examples of the computer readable storage medium may include, but are not limited to, an electrical connection having one or more cables, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the disclosure, a computer readable storage medium may be any tangible medium that may contain or store a program for use by or in connection with an instruction execution system, apparatus, or device. In the disclosure, a computer readable signal medium may include a data signal with computer readable program code embodied therein, which, for example, is propagated in baseband or as part of a carrier wave. Such a propagated signal may take any of a variety of forms, including, but not limited to, electro-magnetic, optical, or any suitable combination thereof. A computer readable signal medium may also be any computer readable medium other than a computer readable storage medium, which may communicate, propagate, or transport a program for use by or in connection with an instruction execution system, apparatus, or device. The program code contained on the computer-readable medium may be transmitted using any appropriate medium, including but not limited to: cables, optical cables, RF (radio frequency), etc., or any suitable combination of the above.

In some implementations, clients and servers may communicate using any currently known or future developed network protocol, such as HyperText Transfer Protocol (HTTP), and may interconnect with digital data communication (such as communication networks) in any form or medium. Examples of communication networks include local area networks (“LANs”), wide area networks (“WANs”), Internet (for example, the Internet), and end-to-end networks (for example, ad hoc end-to-end networks), as well as any currently known or future developed networks.

The computer readable medium may be included in the electronic device, or may exist separately and not be installed in the electronic device.

The computer readable medium carries one or more programs, the one or more programs, when the executed by the electronic device, causing the electronic device to: obtain at least two real-scene images acquired by a virtual reality camera and image acquisition positions of the real-scene images; generating point cloud images corresponding to the real-scene images based on the real-scene images; determining display positions of image acquisition points in a position coordinate system based on the image acquisition positions of the real-scene images; displaying each of the point cloud images based on the display positions, where the displayed point cloud images are used to be spliced to generate panoramic point cloud data.

In some embodiments, the image acquisition positions are determined by a step of determining an acquisition point position, where the step of determining the acquisition point position includes: determining an initial position and a velocity of the virtual reality camera; determining a displacement of the virtual reality camera based on the velocity; and determining a current image acquisition position based on the initial position and the displacement, and determining the current image acquisition position as the initial position.

In some embodiments, the virtual reality camera includes an inertial component, and determining the velocity of the virtual reality camera includes: determining pose information of the virtual reality camera based on first measurement data of the inertial component; determining the velocity of the virtual reality camera based on second measurement data of the inertial component and the pose information.

In some embodiments, the inertial component includes a gyroscope and an accelerometer; and determining the velocity of the virtual reality camera, based on the second measurement data of the inertial component and the pose information comprises: converting an inertial acceleration measured by the accelerometer into a navigation acceleration in a navigation coordinate system based on the pose information; determining the velocity of the virtual reality camera in the position coordinate system based on the navigation acceleration.

In some embodiments, determining the displacement of the virtual reality camera based on the velocity includes determining the displacement of the virtual reality camera in the position coordinate system by integral of the velocity of the virtual reality camera in the position coordinate system.

In some embodiments, the method further includes: displaying position indication information at each of the display positions.

In some embodiments, the method further includes: in response to a movement operation on the displayed position indication information, moving the position indication information based on the movement operation, and moving a point cloud image of the point cloud images based on the position indication information.

Computer program code for carrying out operations of the disclosure may be written in any combination of one or more programming languages, including, but not limited to, an object-oriented programming language such as Java, Smalltalk, C++ and/or the like and conventional procedural programming languages, such as the C programming language or similar programming languages. The program code may be executed entirely on the user's computer, partly on the user's computer, as a stand-alone software package, partly on the user's computer and partly on a remote computer, or entirely on a remote computer or a server. In the scenario involving a remote computer, the remote computer may be connected to the user's computer through any type of networks, including a local area network (LAN) or a wide area network (WAN), or may be connected to an external computer (for example, through the Internet using an Internet Service Provider).

The flowchart and block diagrams in the figures illustrate the architecture, functionality, and operation of possible implementations of systems, methods and computer program products according to various embodiments of the disclosure. In this regard, each block in the flowchart or block diagrams may represent a module, segment, or portion of code, which includes one or more executable instructions for implementing the specified logical function(s). It should also be noted that in some alternative implementations, the functions noted in the blocks may occur in a different order than that noted in the figures. For example, two blocks shown in succession may, in fact, be performed substantially concurrently, or the blocks may sometimes be performed in a reverse order, depending upon the functionality involved. It will also be noted that each block of the block diagrams and/or flowchart, and combinations of blocks in the block diagrams and/or flowchart may be implemented by special purpose hardware-based systems that perform the specified functions or acts, or combinations of special purpose hardware and computer instructions.

The units involved in the embodiments of the disclosure may be implemented through software or hardware. The name of the unit does not constitute a limitation to the unit itself in a certain case. For example, the obtaining unit may also be described as “unit for obtaining a real-scene image”.

The functions described herein above may be performed, at least in part, by one or more hardware logic components. For example, without limitation, example types of hardware logic components that may be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more cables, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

The foregoing description is merely illustrative of the preferred embodiments of the disclosure and of the technical principles applied thereto. It is to be appreciated by those skilled in the art that the disclosure scope of the disclosure is not limited to the technical solution formed by the specific combination of the described technical features. At the same time, it should also cover other technical solutions formed by any combination of the described technical features or equivalent features thereof without departing from the described disclosed concept, for example, a technical solution formed by replacing the above features and the technical features having similar functions disclosed in the disclosure (but not limited thereto) with each other.

In addition, while operations are depicted in a particular order, this should not be understood as requiring that the operations are performed in the particular order shown or in sequential order. Multitasking and parallel processing may be advantageous in certain circumstances. Likewise, while several specific implementation details are included in the above discussion, these should not be construed as limiting the scope of the disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1-10. (canceled)

11. A method for displaying an image, comprising:
obtaining at least two real-scene images acquired by a virtual reality camera, and image acquisition positions of the real-scene images;
generating point cloud images corresponding to the real-scene images, based on the real-scene images;
determining display positions of image acquisition points in a position coordinate system, based on the image acquisition positions of the real-scene images; and
displaying each of the point cloud images based on the display positions, wherein the displayed point cloud images are used to be spliced to generate panoramic point cloud data.

12. The method according to claim 11, wherein the image acquisition positions are determined by a step of determining an acquisition point position determining step; and
wherein the step of determining the acquisition point position comprises:
determining an initial position, and a velocity of the virtual reality camera;
determining a displacement of the virtual reality camera based on the velocity; and
determining a current image acquisition position based on the initial position and the displacement, and determining the current image acquisition position as an initial position.

13. The method according to claim 12, wherein the virtual reality camera includes an inertial component; and
determining the velocity of the virtual reality camera comprises:
determining pose information of the virtual reality camera based on first measurement data of the inertial component; and
determining the velocity of the virtual reality camera based on second measurement data of the inertial component and the pose information.

14. The method according to claim 13, wherein the inertial component comprises a gyroscope and an accelerometer; and
determining the velocity of the virtual reality camera based on the second measurement data of the inertial component and the pose information comprises:
converting, based on the pose information, an inertial acceleration measured by the accelerometer into a navigation acceleration in a navigation coordinate system; and
determining, based on the navigation acceleration, the velocity of the virtual reality camera in the position coordinate system.

15. The method according to claim 12, wherein determining the displacement of the virtual reality camera based on the velocity comprises:
determining the displacement of the virtual reality camera in the position coordinate system, by integral of the velocity of the virtual reality camera in the position coordinate system.

16. The method according to claim 11, further comprising:
displaying position indication information at each of the display positions.

17. The method according to claim 16, further comprising:
in response to a movement operation on the displayed position indication information, moving the position indication information based on the movement operation, and a point cloud image of the point cloud images corresponding to the position indication information.

18. An electronic device, comprising:
one or more processors; and
a storage device for storing one or more programs,
the one or more programs, when executed by the one or more processors, causing the one or more processors to implement acts comprising:
obtaining at least two real-scene images acquired by a virtual reality camera, and image acquisition positions of the real-scene images;
generating point cloud images corresponding to the real-scene images, based on the real-scene images;
determining display positions of image acquisition points in a position coordinate system, based on the image acquisition positions of the real-scene images; and
displaying each of the point cloud images based on the display positions, wherein the displayed point cloud images are used to be spliced to generate panoramic point cloud data.

19. The electronic device according to claim 18, wherein the image acquisition positions are determined by a step of determining an acquisition point position determining step; and
wherein the step of determining the acquisition point position comprises:
determining an initial position, and a velocity of the virtual reality camera;
determining a displacement of the virtual reality camera based on the velocity; and
determining a current image acquisition position based on the initial position and the displacement, and determining the current image acquisition position as an initial position.

20. The electronic device according to claim 19, wherein the virtual reality camera includes an inertial component; and
determining the velocity of the virtual reality camera comprises:
determining pose information of the virtual reality camera based on first measurement data of the inertial component; and
determining the velocity of the virtual reality camera based on second measurement data of the inertial component and the pose information.

21. The electronic device according to claim 20, wherein the inertial component comprises a gyroscope and an accelerometer; and
determining the velocity of the virtual reality camera based on the second measurement data of the inertial component and the pose information comprises:
converting, based on the pose information, an inertial acceleration measured by the accelerometer into a navigation acceleration in a navigation coordinate system; and
determining, based on the navigation acceleration, the velocity of the virtual reality camera in the position coordinate system.

22. The electronic device according to claim 19, wherein determining the displacement of the virtual reality camera based on the velocity comprises:
determining the displacement of the virtual reality camera in the position coordinate system, by integral of the velocity of the virtual reality camera in the position coordinate system.

23. The electronic device according to claim 18, wherein the acts further comprise:
displaying position indication information at each of the display positions.

24. The electronic device according to claim 23, wherein the acts further comprise:
in response to a movement operation on the displayed position indication information, moving the position indication information based on the movement operation, and a point cloud image of the point cloud images corresponding to the position indication information.

25. A non-transitory computer readable medium storing a computer program thereon, wherein the program, when executed by a processor, implements acts comprising:
obtaining at least two real-scene images acquired by a virtual reality camera, and image acquisition positions of the real-scene images;
generating point cloud images corresponding to the real-scene images, based on the real-scene images;
determining display positions of image acquisition points in a position coordinate system, based on the image acquisition positions of the real-scene images; and
displaying each of the point cloud images based on the display positions, wherein the displayed point cloud images are used to be spliced to generate panoramic point cloud data.

26. The non-transitory computer readable medium according to claim 25, wherein the image acquisition positions are determined by a step of determining an acquisition point position determining step; and
wherein the step of determining the acquisition point position comprises:
determining an initial position, and a velocity of the virtual reality camera;
determining a displacement of the virtual reality camera based on the velocity; and
determining a current image acquisition position based on the initial position and the displacement, and determining the current image acquisition position as an initial position.

27. The non-transitory computer readable medium according to claim 26, wherein the virtual reality camera includes an inertial component; and
determining the velocity of the virtual reality camera comprises:
determining pose information of the virtual reality camera based on first measurement data of the inertial component; and
determining the velocity of the virtual reality camera based on second measurement data of the inertial component and the pose information.

28. The non-transitory computer readable medium according to claim 27, wherein the inertial component comprises a gyroscope and an accelerometer; and
determining the velocity of the virtual reality camera based on the second measurement data of the inertial component and the pose information comprises:
converting, based on the pose information, an inertial acceleration measured by the accelerometer into a navigation acceleration in a navigation coordinate system; and
determining, based on the navigation acceleration, the velocity of the virtual reality camera in the position coordinate system.

29. The non-transitory computer readable medium according to claim 26, wherein determining the displacement of the virtual reality camera based on the velocity comprises:
determining the displacement of the virtual reality camera in the position coordinate system, by integral of the velocity of the virtual reality camera in the position coordinate system.

30. The non-transitory computer readable medium according to claim 25, wherein the acts further comprise:
displaying position indication information at each of the display positions.
